(19) United States
(12) Patent Application Publication
(10) Pub. No.: US 2019/0026745 A1
(43) Pub. Date: Jan. 24, 2019

(54) METHOD FOR VERIFYING THE HOLDER OF A SMARTCARD COMPRISING A BIOMETRIC DATA READER EXCHANGING WITH A TRANSACTION TERMINAL

(71) Applicant: IDEMIA IDENTITY & SECURITY FRANCE, Issy-Les-Moulineaux (FR)

(72) Inventors: Sylvain Jerome FROMAGER, Issy-Les-Moulineaux (FR); Francois GERMAIN, Issy-Les-Moulineaux (FR)

(21) Appl. No.: 16/012,664

(22) Filed: Jun. 19, 2018

(30) Foreign Application Priority Data
Jun. 20, 2017 (FR) 1755611

(51) Int. Cl. G06Q 20/40; G06Q 20/34

(52) U.S. Cl. CPC G06Q 20/40145; G06Q 20/3567; G06Q 20/3563; G06Q 20/341

(57) ABSTRACT

A method for verifying the holder of a smartcard, the card being of the type comprising a biometric data reader, wherein the card exchanges with a transaction terminal itself equipped with a biometric data reader, wherein the chip of the card checks the availability of biometric data at the reader of the card and implements two different verification processing operations depending on whether or not the biometric data are available at the reader. It also concerns the smartcard with associated biometric data reader.

The invention relates to smartcards.

More specifically, the inventions proposes a method for verifying the holder of a smartcard comprising a biometric data reader, when said card exchanges with a transaction terminal.

It also proposes a smartcard adapted to implement this method.

### GENERAL TECHNICAL FIELD AND PRIOR ART

Smartcard environment products are subjected to interoperability standards and in particular restrictions regarding size (maximum thickness of 0.84 mm) or conformity with mechanical, weather or chemical stresses. This is a highly competitive environment and product costs are an essential parameter.

With the miniaturization of biometric fingerprint readers, it has been possible for these to be integrated into the environment of smartcards.

Smartcards with integrated biometric reader generally have readers of small size to pay heed to the mechanical stresses to which the card is subjected. The disadvantage is that a small reader therefore provides a small image of the finger and requires specific algorithms to be able to perform a match with the image stored in the card. These biometric cards can also be used in ATMs (Automated Teller Machines), automated fuel pumps and or other automated machines.

These devices “swallow” the whole card and therefore do not allow the holder to place a finger on the reader positioned on the card; on the other hand, increasingly more of these devices (in particular ATMs) incorporate large-size fingerprint readers (14×22 mm) to allow validation of payment.

### GENERAL SUMMARY OF THE INVENTION

It is one general objective of the invention to propose a smartcard solution which allows broader utilization than in the prior art.

For this purpose, the invention proposes a method comprises the following steps carried out by the smartcard: checking the availability of biometric data at the first reader; if biometric data are available at the first reader, implementing first verification processing of these available biometric data; if no biometric data are available at the first reader, implementing second verification processing of biometric data read by the second reader and then received by the smartcard, the second processing differing from the first processing.

Said method allows verification of the holder from biometric data acquired by an integrated biometric reader, when such data are available. It also allows verification of the holder via exchange with a terminal that is itself equipped with a biometric reader when the integrated biometric reader cannot be used.

In particular:
when biometric data are available at the reader of the smartcard, the chip of said card implements processing to compare these data with a first set of biometric data memorized in said chip, this operation conforming to a first algorithm;
when biometric data are not available at the reader of the smartcard:
   the terminal transmits biometric data, read by the biometric data reader of the terminal, to the chip of said card; and
   the chip of said card implements processing to compare these data with a second set of biometric data memorized by said chip, this processing conforming to a second algorithm.

The first set of biometric data for comparison can be encoded over fewer than 100 octets.

The processing conforming to the second algorithm can carry out verification in accordance with an ISO algorithm.

In one particular embodiment, when the biometric data are available at the smartcard reader, the chip of said card transmits a first set of AIP, AFL data to the terminal, and when these biometric data are not available the chip of said card transmits a second set of AIP, AFL data to the terminal.

For example, the biometric data are fingerprint data.

The invention also concerns a smartcard with biometric data reader (fingerprint reader), characterized in that the chip of said card is adapted to implement a verification method of the above-described type.

### PRESENTATION OF THE FIGURES

Other characteristics and advantages of the invention will become further apparent from the following description that is solely illustrative and nonlimiting, and is to be read in connection with the appended Figures in which:

FIG. 1 schematically illustrates exchanges between a smartcard, equipped with a biometric reader, and a smartcard terminal itself integrating a biometric reader;

FIGS. 2a and 2b illustrate two embodiments of holder verification depending on whether or not a biometric image is acquired by the reader of the smartcard;

FIG. 3 illustrates different steps of verification processing carried out when use is made of the card reader;

FIG. 4 illustrates different steps of verification processing carried out when use is made of the reader on the terminal.

### DESCRIPTION OF ONE OR MORE EMBODIMENTS AND IMPLEMENTATIONS

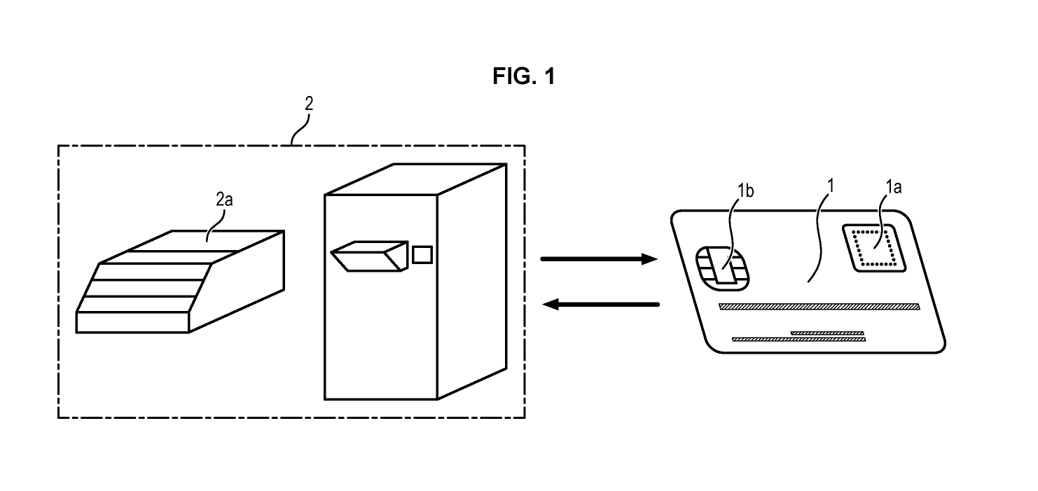

FIG. 1 illustrates a smartcard 1 and a smartcard reading terminal 2.

The smartcard 1 comprises an integrated biometric reader 1a and a processor 1b. For example, the reader 1a is a fingerprint reader.

The terminal 2 can be of any type (ATM, payment terminal, etc.). It is also provided with a biometric reader 2a that for example is also a fingerprint reader.

The chip 1b of the card 1 integrates the different data needed for verification processing, and in particular:
CVM list (Cardholder Verification Method);
AIP data (Application Interchange Profile);
AFL data (Application File Locator);
etc.

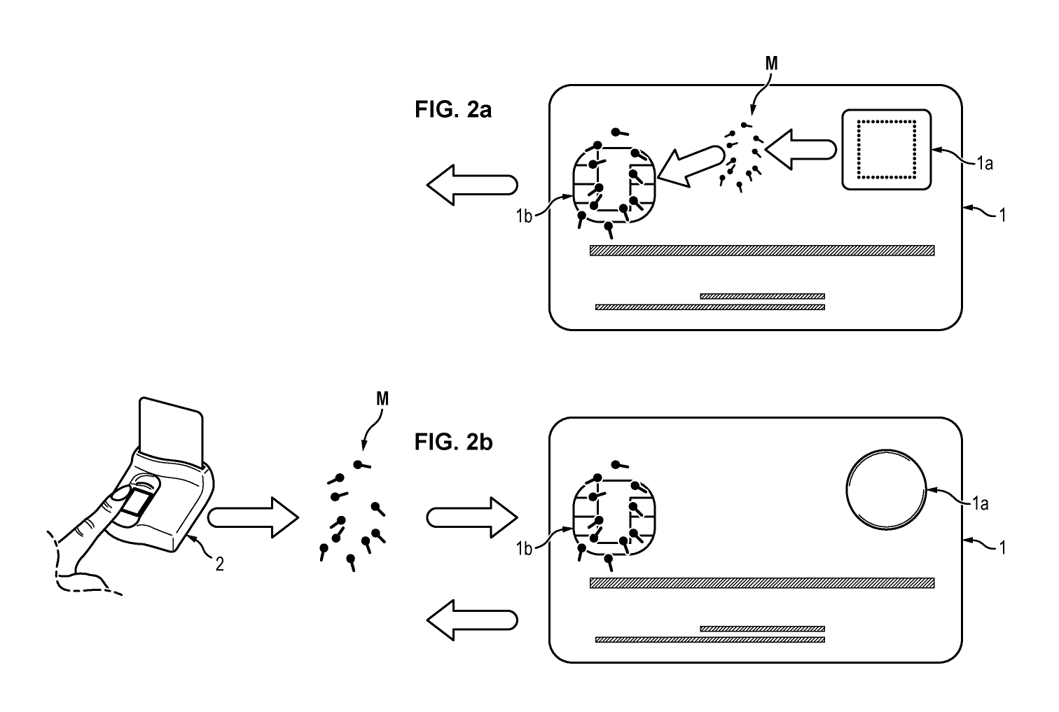

More specifically, the chip memorizes two sets of AIP, AFL data which will respectively be used:
one in the event of holder verification via readout of holder biometric data by the reader 1a of the smartcard 1 (FIG. 2a);
the other in the event of holder verification via readout of biometric data by the reader 2a of the terminal 2 (FIG. 2b).

In the first case (FIG. 2a), the small-size image acquired by the reader 1a is processed by the chip 1b to extract minutiae M therefrom, and to make a comparison with reference minutiae previously memorized in the card (reference data called template).

Typically, this template and the extracted minutiae are each encoded over fewer than 100 Octets.

The comparison processing carried out is processing that conforms to a specific algorithm adapted for this purpose.

In the second case (FIG. 2b), the image read by the reader 2a is processed by the chip to extract therefrom the minutiae M of the holder. Verification processing is performed at said chip using an algorithm conforming to the ISO algorithm conventionally used by the different transaction standards for smartcards (EMV, Mastercard, Visa, etc.).

Comparison is carried out with a second set of minutiae also previously memorized in the chip 1b.

This set of minutiae is typically encoded over 60 kOctets or less.

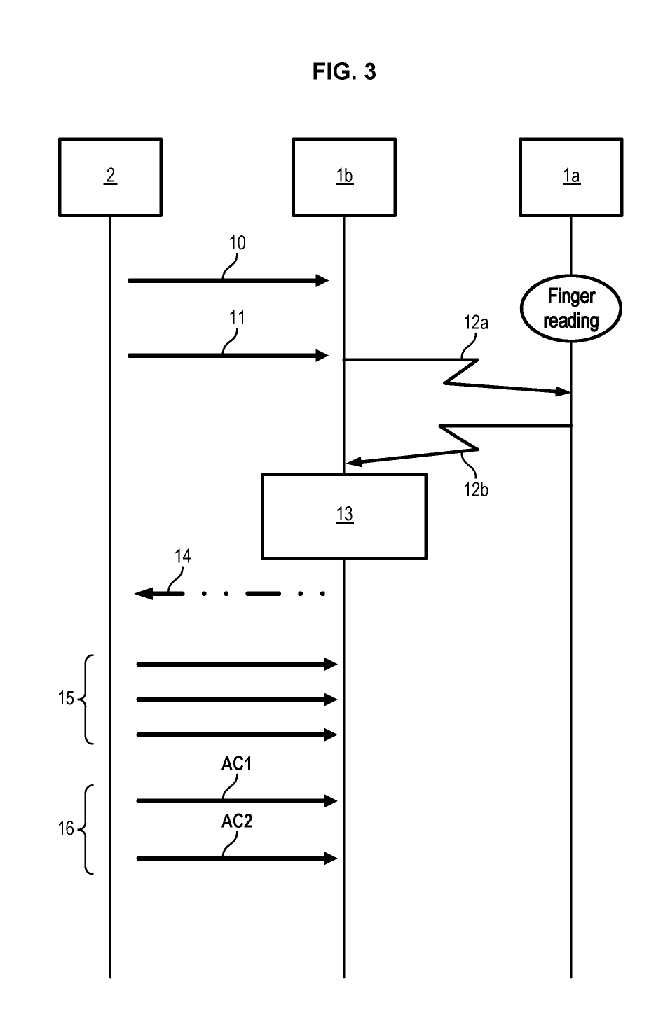

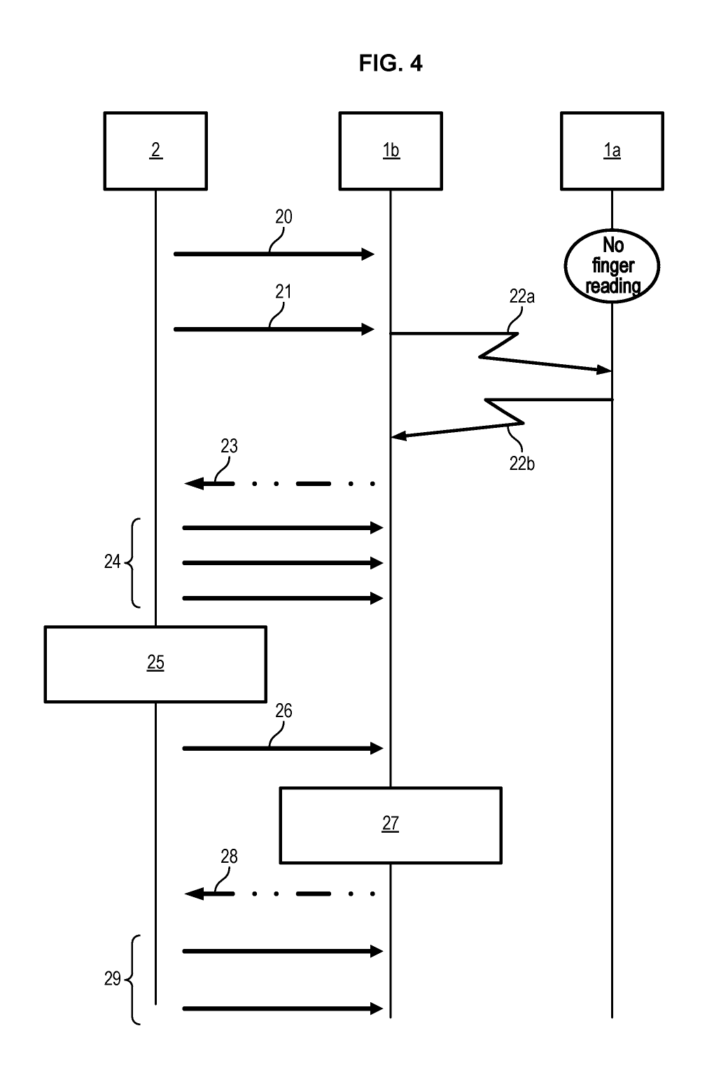

The steps of a transaction are illustrated in FIGS. 3 and 4.

As will be understood on reading these Figures, the use of the biometric reader and proprietary algorithm embedded in the card is given priority over use of the ISO algorithm.

If the card reader is used, the terminal 2 connects to the chip 1b (step 10), and sends a request to said chip 1b requesting processing options (step 11).

The chip 1b verifies that a finger is held on the reader 1a and acquires the image of the corresponding fingerprint (steps 12a and 12b).

It processes this image to extract the minutiae M therefrom and verifies whether they match the minutiae previously stored for the holder (step 13) (first set of minutiae).

This verification is performed via an adapted proprietary algorithm.

Once verification is completed, the chip 1b transmits to the terminal 2 the AIP, AFL data corresponding to this embodiment with readout by the card reader (step 14).

The terminal 2 exchanges with the chip 1b to transmit the different transaction data (exchanges 15) and generate the different required cryptograms AC (exchanges 16).

The case in which the card reader is unable to used is illustrated in FIG. 4.

After connection (step 20) and after the terminal 2 has transmitted a request to the chip 1b requesting processing options, if the chip 1b ascertains the absence of a fingerprint image able to be acquired at reader 1b after a certain lapse of time (steps 22a and 22b), said chip 1 transmits to the terminal the different AIP, AFL data of the second processing mode (transmission 23) (mode associated with the ISO algorithm and conforming to the different existing standards (EMV, Mastercard, Visa, etc.)).

In return, the terminal 2 transmits to the chip 1b the different transaction data (steps 24) required for the transaction together with the biometric data acquired by the reader 2a of said terminal 2 (acquisition 25 and transmission 26).

These biometric data are verified by the chip 1b via comparison with the other set of previously memorized biometric data (step 27).

The match is verified in particular by means of an algorithm compatible with the ISO algorithm.

Once the match is verified, the chip 1b transmits the result thereof to the terminal 2 (step 28) which generates the application cryptograms AC1, AC2 corresponding to the transaction (steps 29).

1. Method for verifying the holder of a smartcard, the card comprising a first biometric data reader, and the card communicating with a terminal comprising a second biometric data reader, wherein the method comprises the following steps carried out by the smartcard:
checking the availability of biometric data at the first reader;
if biometric data are available at the first reader, implementing first verification processing of these available biometric data;
if no biometric data are available at the first reader, implementing second verification processing of biometric data read by the second reader and then received by the smartcard, wherein the second processing differs from the first processing.

2. The method according to claim 1, wherein the first verification processing comprises a comparison of the readout available biometric data with biometric data memorized by the smartcard.

3. The method according to claim 1, wherein the second verification processing comprises a comparison of the biometric data read by the second reader and then received by the smartcard with biometric data memorized by the smartcard.

4. The method according to claim 2, wherein the biometric data memorized by the smartcard are encoded over fewer than 100 octets.

5. The method according to claim 1, wherein the second verification processing comprises verification using an ISO algorithm.

6. The method according to claim 1, comprising transmitting by the smartcard to the terminal of data able to trigger a transmission of said biometric data read by the terminal reader to the smartcard.

7. The method according to claim 6, wherein the data able to trigger said transmission are transmitted when biometric data are not available at the first reader within a predetermined lapse of time.

8. The method for verifying the holder of a smartcard according to claim 1, wherein
when the first processing is carried out, the card transmits to the terminal a first set of data of Application Interchange Profile (AIP) type, and of Application File Locator (AFL) type; and
when the second processing is carried out, the card transmits to the terminal a second set of AIP, AFL data.

9. The method according to claim 1, wherein the biometric data are fingerprint data.

10. Smartcard comprising a first biometric data reader, a communication interface with a terminal comprising a second biometric data reader, and a data processing unit configured:
to check availability of biometric data at the first reader;
if biometric data are available at the first reader, to implement first verification processing of these available biometric data;
if there are no biometric data available at the first reader, to implement second verification processing of biometric data read by the second reader then received by the smartcard, wherein the second processing differs from the first processing.

11. System comprising a smartcard according to claim 10, and a terminal comprising a second biometric data reader.
